(19) United States
(12) Patent Application Publication
(10) Pub. No.: US 2015/0310074 A1
(43) Pub. Date: Oct. 29, 2015

(54) SYSTEM AND METHOD FOR GRAPHIC REPRESENTATION OF RELATIONSHIPS

(71) Applicant: Strategic Thinking Technologies LLC, Akron, OH (US)

(72) Inventors: Rodolfo Salas, Chagrin Falls, OH (US); Ricardo Salas, Parkville, MO (US); Donzell Taylor, Green, OH (US)

(73) Assignee: Strategic Thinking Technologies LLC, Akron, OH (US)

(21) Appl. No.: 14/259,637

(22) Filed: Apr. 23, 2014

(51) Int. Cl. G06F 17/30; G06F 3/0484

(52) U.S. Cl. CPC G06F 17/30554; G06F 17/30595; G06F 3/04842

(57) ABSTRACT

This disclosure is of a computer that is programmed to graphically show an organization that the computer user wants to influence, the user's team, and the user's competition, each of which is populated with graphical representations of associated individuals. The computer is programmed to show how individuals feel about other individuals and about the user. The computer is programmed to store multiple such graphical representations and indicate if a particular individual appears in more than one.

### I. BACKGROUND

A. Field of Invention

This invention pertains to the art of strategizing, and more specifically to methods and apparatuses for graphically representing relationships among individuals.

B. Description of the Related Art

It is known in the art that an organization frequently allocates the individuals associated with the organization in hierarchies, where each higher level includes less individuals but with more authority than individuals at lower levels. If someone who is not part of the organization (an external person) wants to influence the organization, that someone would ideally be able to influence the individual or individuals at the highest level or levels of the organization.

However, the external person may not know who is at the highest level or levels of the organization. The external person may not have a personal relationship with individuals at the desired level or levels, even if the external person knows who the individuals are. In addition, the external person may have competitors (who are not part of the organization) who also want to influence the organization. On the other hand, the external person may have friends who do know information about the organization that the external person does not or who do have a personal relationship with individuals of the organization. These friends may be able to establish a relationship between the external person and individuals of the organization.

What is needed, therefore, is a strategy method or tool to aid the external person in determining the individuals of the organization to influence, resources that the external person has that may help achieve the external person's goals, and competitors or threats to be aware of The present invention addresses this need.

### II. SUMMARY

In accordance with one aspect of the present invention, a computer includes a processor, at least one input device, and at least one output device; wherein the computer is programmed to: a) show, using the at least one output device, a main display that shows 1) an organization object, 2) a user object, and 3) at least one competition object; b) import data from a customer relationship management system and convert into individual objects; c) populate the organization object, the user object, and the at least one competition object with the individual objects, wherein a number of the individual objects and a position of each individual object is determined using the at least one input device; d) set and display attributes of each individual object, wherein the attributes are set using the at least one input device; e) set relationships between any two individual objects using the at least one input device; f) display the relationships between a selected individual object and all other individual objects with which the selected individual object has a relationship, wherein the selected individual object is selected using the at least one input device; g) store a plurality of main displays; and h) show the main displays in which a selected individual object appears when queried using the at least one input device.

In accordance with another aspect of the present invention, a method includes the steps of: a) providing a computer including a processor, at least one input device, and at least one output device; b) initializing in the computer a main display that shows, using the at least one output device, 1) an organization object, 2) a user object, and 3) at least one competition object; c) importing data from a customer relationship management system and converting into individual objects; d) populating the organization object, the user object, and the at least one competition object with the individual objects, wherein a number of the individual objects and a position of each individual object is determined using the at least one input device; e) setting and displaying attributes of each individual object, wherein the attributes are set using the at least one input device; f) setting relationships between any two individual objects using the at least one input device; g) configuring per steps a)-f) and storing a plurality of main displays; h) selecting one individual object in one main display using the at least one input device; and i) showing all other main displays in which the selected one individual appears.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram of a computer.

FIG. 2 is a view of a generic display according to one embodiment of the invention.

FIG. 3 is a view of a display populated with individuals.

FIG. 4a is a view of the attributes that may be assigned to each individual.

FIG. 4b is a view of the legend for lines connecting individuals.

FIG. 5 is a view of a display showing individuals with assigned attributes.

FIG. 6 is a view of a display showing relationships of one individual.

FIG. 7 is a view of a generic display according to another embodiment of the invention.

FIG. 8 is a view of a generic display according to another embodiment of the invention.

FIG. 9 is a view of a display populated with individuals.

### IV. DETAILED DESCRIPTION

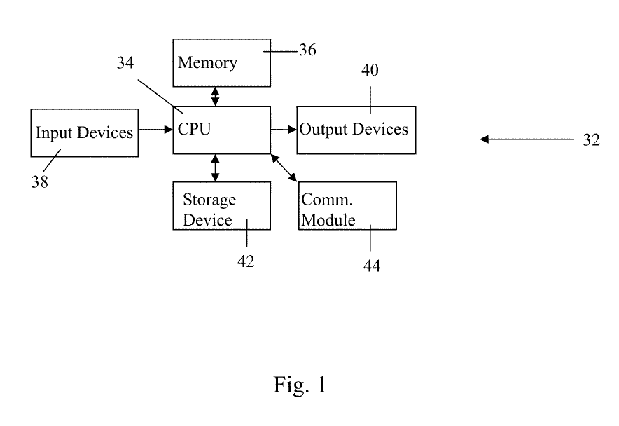

Referring now to the drawings wherein the showings are for purposes of illustrating embodiments of the invention only and not for purposes of limiting the same, and wherein like reference numerals are understood to refer to like components, FIG. 1 shows one embodiment of the invention, which may include a specially-programmed computer 32. The computer 32 may include a central processing unit (CPU) 34 that may execute the programmed code for implementing the various steps discussed further below. The computer 32 may also include at least one input device 38 to allow a user to control the computer 32 and provide input variables to the computer 32. The input device 38 may include, but is not limited to, a touch screen, a keyboard or keypad, a mouse, a touchpad, and a track-stick.

The computer 32 may also include memory 36 for temporarily storing program code during execution. The CPU 34 may write data to the memory 36 and may read data from the memory 36. The computer 32 may include at least one output device 40, which may include, but is not limited to, a display or monitor, a printer, and a projector. The computer 32 may include a communication module 44 that allows the computer 32 to communicate with other computers, which may be through a network. The communication may be wired or wireless. In alternative embodiments, the communication may be by LAN, WiFi, Bluetooth, infrared, RF, or fiberoptic. The computer 32 may also include a storage device 42, which may be used for storing the program code, user-entered parameters, and processed and saved results. The storage device 42 may include, but is not limited to, a hard disk drive, a solid-state drive, and an optical disk drive.

In one embodiment, at least one input device 38, the CPU 34, the memory 36, at least one output device 40, a storage device 42, and a communication module 44 may be housed in one enclosure. Examples may include a tablet, a laptop computer, or a mobile phone. In another embodiment, the input devices 38 and the output devices 40 may be housed separately from the memory 36, CPU 34, storage device 42, and communication module 44. An example may include a desktop computer. In another embodiment, the storage device 42 may be housed at a location remote from the other components of the computer 32 and may be accessed through the communication module 44. An example may include cloud storage.

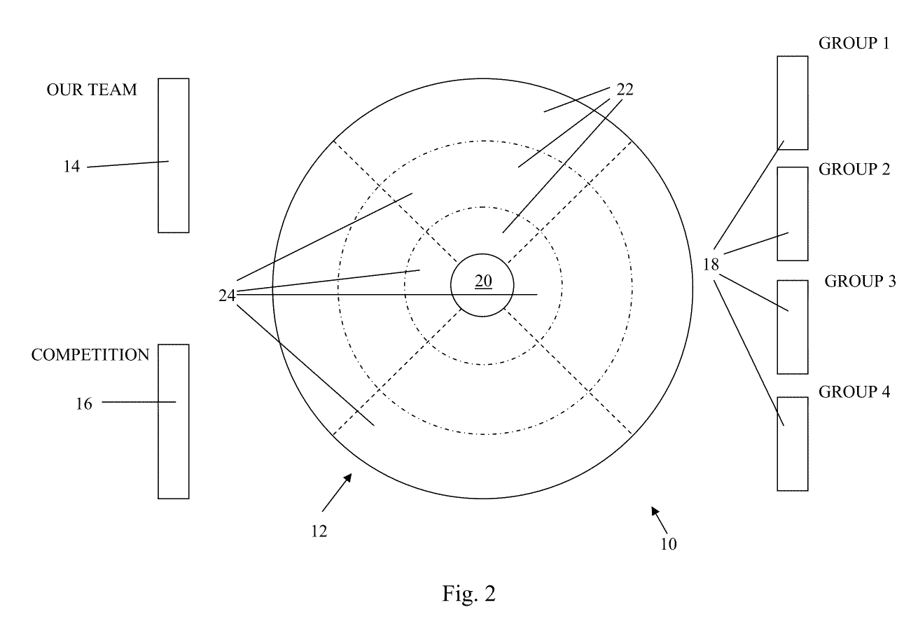

The computer 32 may be programmed to visually represent an organization, showing individuals inside the organization and external individuals who have or want to have influence over individuals inside the organization. When a new strategy or initiative is initialized, the computer 32 may show an empty, generic main display 10, as shown in FIG. 2. The main display 10 may show an object 12 that represents the organization that the user of the software wants to influence. This organization object 12 is shown as a circle, but it may be represented as any desired shape, including, but not limited to, a square, a rectangle, and a triangle. While this discussion refers to influencing an organization, this invention may also be used to influence a department or unit within an organization, in which case the object 12 represents the department or unit and not the entire organization. Furthermore, the organization is not limited to a legal entity but can include a loose association of individuals that have a common purpose.

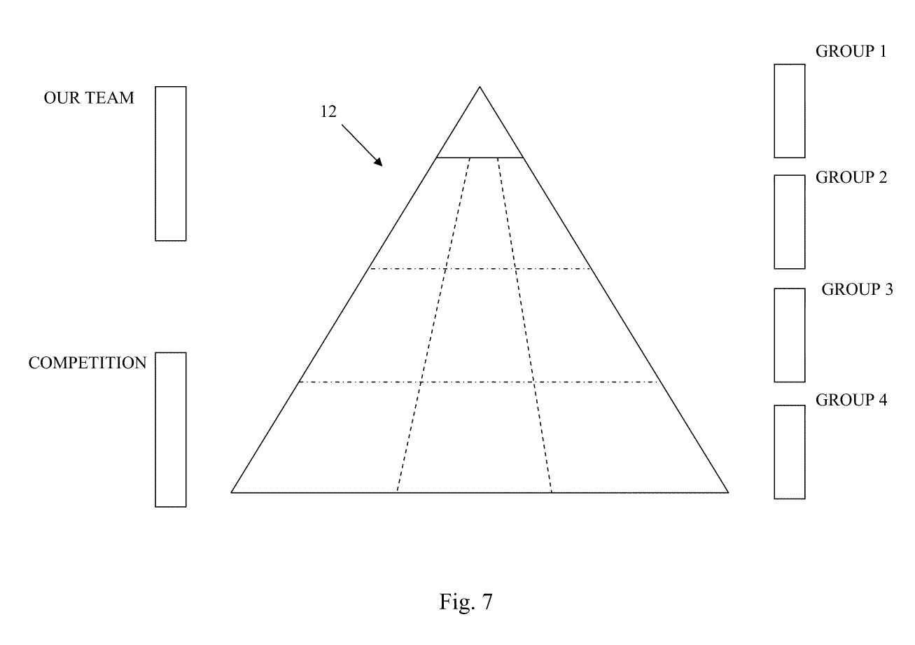

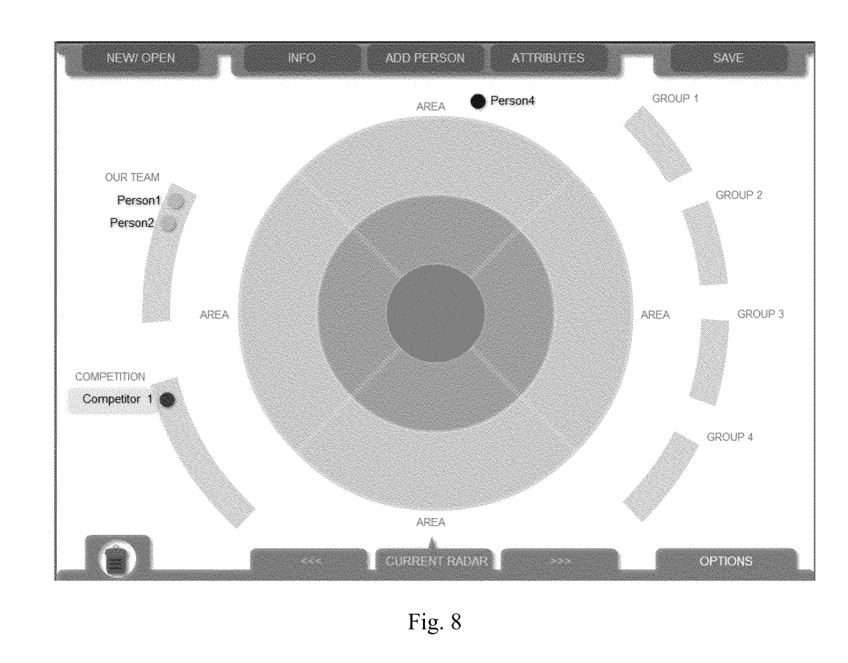

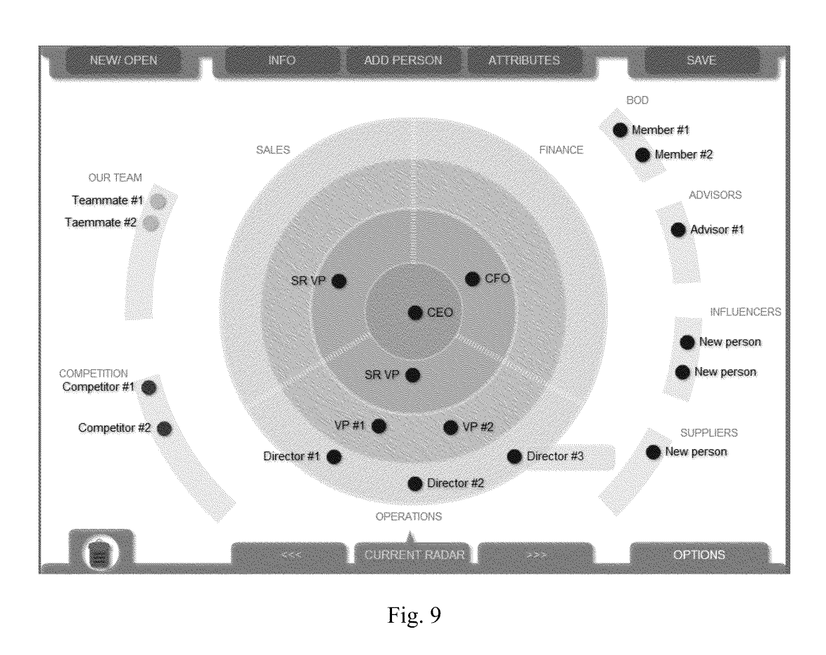

The organization object 12 may be divided into pie slices or wedges 24, where each slice 24 may represent a department, subgroup, or unit within the organization. In one embodiment, these slices 24 may represent vertically-parallel divisions within an organization. Each slice 24 may also represent a less formal division within the organization. The organization object 12 may also be divided into concentric rings 22, where each ring 22 may represent a hierarchical level within the organization. The outer ring 22 may represent a lower hierarchical level with less influence or authority over the organization, with the rings 22 closer to the center may represent higher hierarchical levels with more influence or authority over the organization. The center 20 of the object 12 may represent the top leadership or highest rank of the organization. The computer 32 may be programmed to divide the object 12 into as many slices 24 and rings 22 as the user desires. The object 12 may be shaped like a pie, bull's eye, or radar screen. If the object 12 is a shape other than a circle, the visualization of authority or influence may be modified appropriately. For example, if a pyramid or triangle is used, the apex may represent the top leadership, with lower steps or segments representing levels with less influence or authority, as shown in FIG. 7.

The main display 10 may also show an object 14 representing the user. The main display 10 may also show an object 16 representing competition of the user. The software may be programmed to display as many competition groups or competition objects 16 as the user desires. The main display 10 may also show other objects 18 representing external influencers of the organization. These objects 14, 16, 18 may be represented by rectangles, arcuate rectangles, circles, squares, or triangles. The computer 32 may be programmed to provide as many external influencer objects 18 as the user desires. In one embodiment, the objects 14, 16 representing the user and the user's competition may be positioned on one side of the organization object 12, and the objects 18 representing external influencers may be positioned on the other side of the organization object 12. In another embodiment, the objects 14, 16, 18 may be positioned on one side of the organization object 12. In another embodiment, the objects 14, 16, 18 may be positioned to encircle or surround the organization object 12.

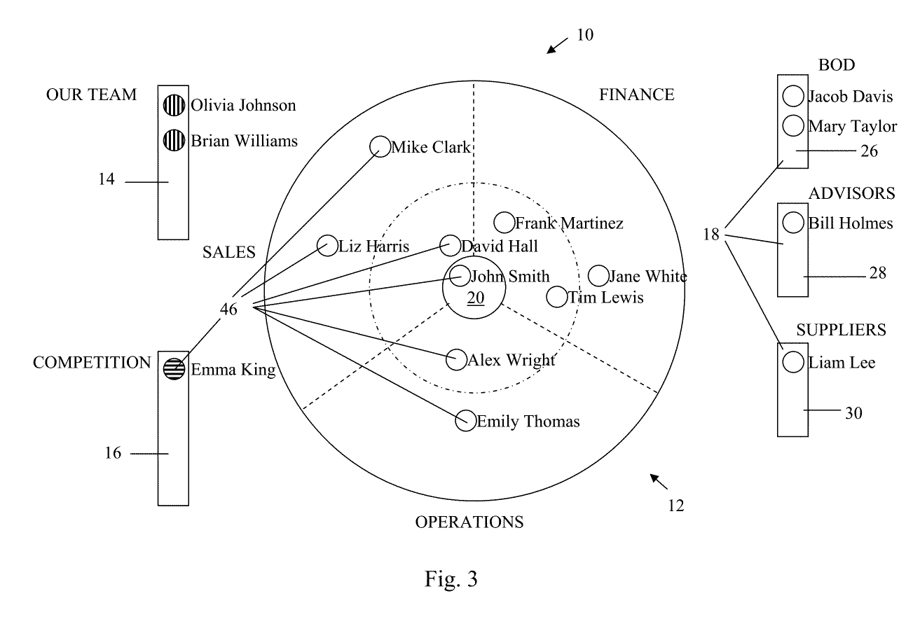

After initializing a new project, strategy, or initiative, the user may set up and populate the main display as necessary. FIG. 3 shows a simple example. The user may determine the number of hierarchical levels 22 that the organization object 12 should have. FIG. 3 shows that the organization object 12 has two hierarchical levels 22 in addition to the top leadership 20. The user may determine the number of departments or units 24 that the organization should have. FIG. 3 shows that the organization object 12 has three departments. The user may determine the number of external influencer groups 18 to include. FIG. 3 shows three such groups 18: board of directors 26, advisors 28, and suppliers 30. The external influencer groups 18 may also include partners. The software may be programmed to allow labeling the organization's departments 24 and external influencer objects 18.

The example shown in FIG. 3 and described below is of a sales strategy, where the organization to be influenced is a company having sales, finance, and operations departments, with a chief executive officer (CEO) in the position of top leadership 20. One embodiment of the invention may be used for sales purposes, where the user wishes to influence an organization to become a customer or client of the user to purchase goods or services from the user. Another embodiment of the invention may be used for military purposes, where the user wishes to influence another military unit (whether of the same or a different state) to align with the user. Another embodiment of the invention may be used for intelligence purposes, where the user wishes to infiltrate and influence an organization. Other embodiments of the invention may be used for social or political purposes, where the user wants to influence other connected or associated individuals.

After setting up the structure of the organization and external influencers, the user may populate the main display 10 with known individuals, each of which may be represented by an individual object 46, which may be a circle, square, triangle, or any other shape or symbol. To avoid clutter, FIG. 3 only identifies some, but not all, of the individual objects 46 with the reference “46.” The software may allow naming the individual objects 46 and displaying the name by the individual object 46 on the main display 10. The user may place the individual 46 with the greatest authority in the organization, such as the CEO, in the center 20. In one embodiment, the user may click (or touch where a touch screen is an available input device 38) and drag individuals 46 to the appropriate locations. The user may then place other organization individuals 46 in the appropriate department and hierarchy level of the object 12. In the example shown in FIG. 3, John Smith is the CEO of the organization. Tim Lewis and Frank Martinez are both vice presidents of the finance department. David Hall is a vice president of the sales department. Alex Wright is a vice president of the operations department. The first ring 22 surrounding the center 20 is a vice president level. The ring 22 surrounding the vice president level may be a supervisor level. Thus, Mike Clark and Liz Harris are supervisors of the sales department. Jane White is a supervisor of the finance department. Emily Thomas is a supervisor of the operations department. The rings 22 may be characterized as necessary. For example, the ring 22 closest to the center 20 may be senior vice presidents, the next ring 22 may be vice presidents, etc.

The user may populate the external influencing groups 18 with known individuals 46. In the example shown in FIG. 3, Jacob Davis and Mary Taylor sit on the board of directors 26. Bill Holmes is an external advisor 28 to the organization. Liam Lee is a supplier 30 to the organization. The user may populate the user's team or user object 14 with individuals 46, whether employees, other agents, or contractors. Olivia Johnson and Brian Williams are on the user's team in the example shown in FIG. 3. The user may populate the competition group 16 with known individuals 46. Emma King is the competition in the example shown in FIG. 3.

In one embodiment of the invention, the user may manually add each new individual 46 and input data about the individual 46, such as the individual's name and contact information. Contact information may include, but is not limited to, a work phone number, a mobile number, a home phone number, an email address, and a mailing address. In another embodiment, the user may import data from a customer relationship management (CRM) system that was previously exported. CRM systems may include, but are not limited to, Microsoft Dynamics, SalesForce, and Data Loader. The user may export from the CRM system all contacts related to a client or project, for example. In one example, the exported data may be in a comma-separated variable (CSV) format. When the user imports the data, the software displays a list of imported individuals, and the user may select and place each individual 46 within the main display 10 as appropriate. The imported data may also include contact information of the imported individuals. A user may populate all individuals 46 known to be associated with the user, the organization, the external influencing groups, or the competition; or the user may populate only a selected number of individuals 46 in each group as desired by the user, which may include only the individuals 46 that are relevant to a particular initiative or project.

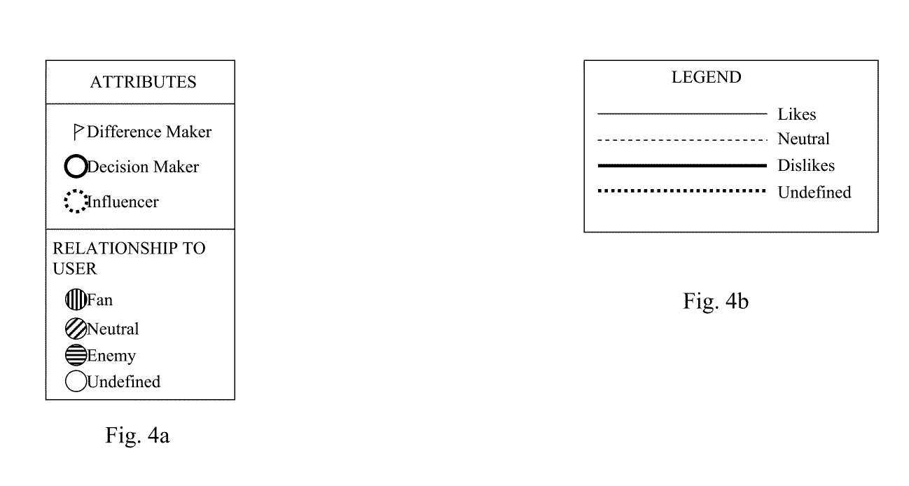

Once the user populates the relevant individuals 46, the user may set attributes for each individual 46 based on the user's knowledge of such attributes. FIG. 4a shows a legend of the attributes that are shown in the figures. The user may indicate the relationship status of every individual 46 on the main display 10, whether the individual 46 likes the user (fan or positive), is neutral to the user (neutral), dislikes the user (enemy or negative), or is undefined (undefined). In one embodiment, the attributes show how loyal each individual 46 is toward the user. In one embodiment, a fan may be indicated by green color, a neutral may be indicated by yellow color, an enemy may be indicated by red color, and an undefined may be indicated by blue or purple color. In another embodiment, different colors may be used. In another embodiment, fill patterns may be used (as shown in the figures).

As the user adds individuals 46 to the main display 10, each individual 46 may start as undefined by default. The user may then select the individual 46 and define how the user believes that individual 46 feels about the user. In one embodiment, the individuals 46 on the user's team 14 may start as fans by default, as shown in FIG. 3. In another embodiment, the individuals 46 of the competition 16 may start as enemies by default. In another embodiment, the software may properly indicate the relationship of every individual 46 imported from a CRM system if the CRM system has a field to indicate such relationship of the individual 46 to the user.

The user may also indicate the level of influence an individual 46 has on the target organization 12. An individual 46 may have a standard or low level of influence (no indication), a moderate level of influence (influencer), or a very high level of influence (decision maker). In one embodiment, the software designates an influencer by a red thick outline and a decision maker by a black thick outline. In another embodiment, the software designates an influencer by a thick dashed outline and a decision maker by a thick solid outline, as shown in FIG. 4a. In other embodiments, other designation means may be used. Also, an individual 46 who is an influencer or decision maker may be further designated as a difference maker to indicate the importance of establishing a good relationship with that individual 46 because of that individual's influence or relationship to other individuals 46. The difference maker may have the ability to make important decisions within the organization. In one embodiment, the software designates a difference maker by a flag. In other embodiments, other designation means may be used. In another embodiment, these attributes may represent the user's prediction of whether an individual 46 is likely to be a passive adviser or observer, or an active decision or difference maker.

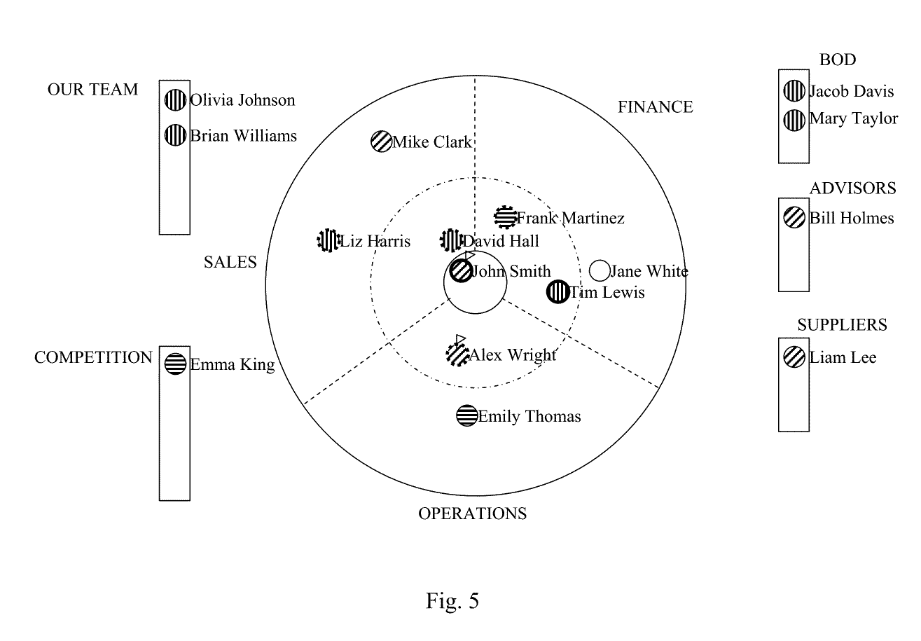

FIG. 5 shows the example of FIG. 3 after the attributes of the individuals 46 have been further set. The user's team 14 is designated as fans, while the competition 16 is designated as enemy. The user has indicated that he believes that the board of directors 26 members both like the user, while the advisor 28 and supplier 30 are neutral toward the user. The user has also indicated that the CEO and Mike are neutral toward the user, while Liz, David, and Tim have a positive relationship with the user. The user has indicated that Frank and Emily do not like the user. The user has not defined Jane's attribute because the user does not know how she feels about the user.

The user has further indicated that the CEO and Tim are decision makers, and that Liz, David, Frank, and Alex are influencers. The user has also indicated that the CEO and Alex are difference makers. Looking at the main display 10, the user can see that he should maintain the positive relationships with Liz, David, and Tim because of their influence. The user should focus on developing a positive relationship with Alex and John because they are difference makers that are neutral to the user. Also, because Frank is an influencer, the user should try to improve the relationship with Frank so that the relationship is at least neutral. The user could try to improve the relationship with Emily, Mike, and Jane, but they are not high priorities at the moment because of their reduced influence in the organization. The user can also see that he is on fairly good terms with other external influencers 18 of the organization.

After populating the individuals 46, the user may indicate the known relationships between individuals 46 on the main display 10. This indication of relationships may be done before or after setting the attributes of the individuals 46 (regarding their relationships to the user and their influence on the organization). The attributes and indication of relationships may also be done concurrently. The user may select any two individuals 46 on the main display 10 to indicate that the two individuals 46 have a relationship. In another embodiment, the user may select a first individual 46 and drag a cursor to a second individual 46 to indicate a relationship between the individuals 46. The user may indicate all known relationships between individuals 46 on the main display 10, or the user may indicate only the relationships that are relevant for the current initiative or project.

Once a relationship between two individuals 46 has been indicated, the user may then indicate how one of the two individuals 46 feels about the other individual 46 and how the other individual 46 feels about the first individual 46. FIG. 4b indicates a legend for the relationship indicators between individuals 46 on a main display 10. An individual 46 may like (positive), be neutral toward, or dislike (negative) another individual 46; also, the relationship may be undefined, perhaps because its quality is unknown to the user. In one embodiment, a green line may indicate that the source individual 46 likes the target individual 46, a red line may indicate dislike, a yellow line may indicate a neutral relationship, and a blue or purple line may indicate an undefined relationship. In another embodiment, different colors may be used. In another embodiment, line style and thickness may be used to indicate relationships, as shown in the figures.

Because the lines indicate how one individual 46 feels about another individual 46, there may be two lines, which may be overlapping (or one bidirectional line), in any relationship between two individuals 46, in one embodiment. In another embodiment, if the overlapping lines are not of the same state, condition, or attribute, the software may indicate such, for example, by a different color of the line or by a symbol (such as a slash) on the overlapping lines. In another embodiment, the lines may include arrows pointing from a source individual 46 to a target individual 46, where the lines are adjacent and not overlapping. Thus, in one embodiment, selecting an individual 46 displays how that individual 46 feels about other individuals 46 and how other individuals 46 feel about the selected individual 46, where such relationships have been indicated. In another embodiment, selecting an individual 46 displays only how that individual 46 feels about other individuals 46, but not how other individuals 46 feel about the selected individual 46.

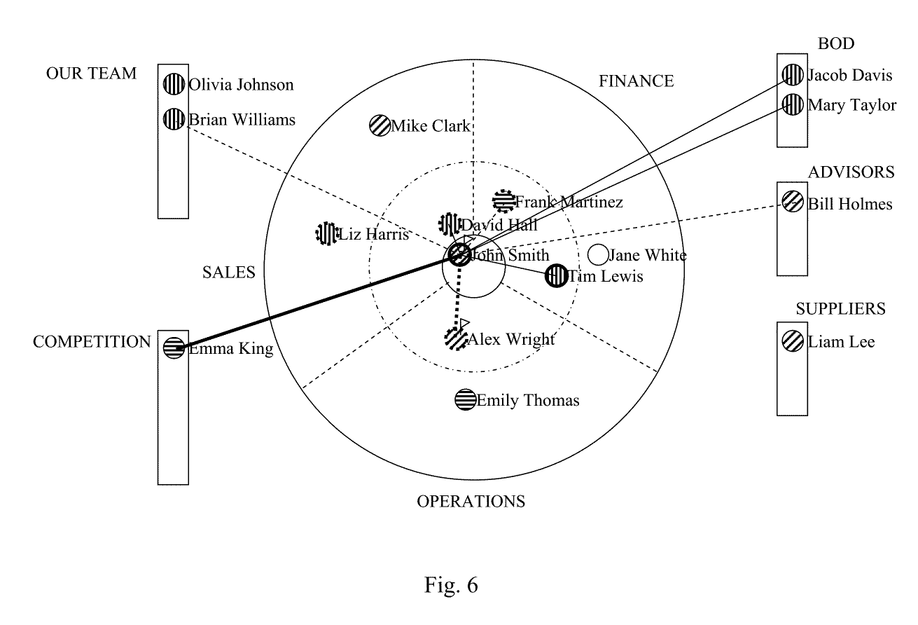

To avoid a clutter on the main display 10, the software may hide all of the relationship lines. When the user selects or clicks on an individual 46, all of the relationship lines of the individual 46 may then be displayed, as shown in FIG. 6 for the CEO. The CEO likes the individuals 46 on the board of directors 26, David, and Tim (and vice versa). The CEO dislikes the competition (and vice versa). The CEO is neutral toward Frank, advisor Bill, and the user's team-member Brian (and vice versa). The CEO has a relationship with Alex, but the user has not defined it, perhaps because the user does not know whether the CEO likes, dislikes, or is neutral toward Alex (and vice versa). Clicking on another individual 46 may cause the previously-selected individual's relationship lines to disappear and the newly-selected individual's relationship lines to be displayed. In another embodiment, an individual's relationship lines may remain displayed until the user clicks on that individual 46 again to cause the relationship lines to disappear.

Viewing FIG. 6, the user sees that he may use the user's relationships with Tim, David, Jacob, and Mary (who all are fans of the user) to try to improve the relationship with the CEO so that the CEO would become a fan of the user (because the CEO likes the above-named individuals). The user may try to set up an event, such as a golf game or dinner, that includes the above-mentioned individuals. The user has some relief in knowing that the CEO does not like the competition.

The main display 10 may also be used to indicate relationships between individuals 46 within the organization based on the physical proximity or distance between them. The closer two individuals 46 are, the closer or more intimate their relationship may be. Such indication may be helpful in addition to the relationship lines because the indication would be visible even if the lines are hidden. The user may position the individuals 46 appropriately while populating the main display 10, while setting attributes for the individuals 46, while indicating relationship lines, or at any other time.

In the example shown in FIG. 5, the CEO is positioned closer to the sales slice 24, which may indicate a close relationship with the sales department, which may be because the CEO came from that department. David is positioned close to the CEO, which may indicate that the two work close together. Tim and Alex are positioned further away from the CEO, which may indicate that they do not work often with the CEO. The positioning does not necessarily indicate that the CEO does not like Tim (as indicated to the contrary in FIG. 6). Tim and Jane appear to have a fairly close working relationship based on their positioning.

The computer 32 implementing the above-described software may be used in accordance with the above-described steps to instantly and dynamically visualize bi-directional relationships in an organization to aid the user in formulating strategies to achieve an initiative. The populated and configured main display 10 may be viewed as a relationship map. The user may work toward the initiative goal by focusing on establishing good relationships with key influential individuals of the organization by utilizing the user's relationships with individuals within and outside of the organization. The user may identify relationships that should be transformed (from negative, enemy, or dislike to positive, fan, or like). The user may leverage decision makers who are (or have become) fans and, as a result, gain decisions by the organization that are favorable to the user. The user may update at any time the various individuals and related attributes as new information becomes available to the user. The visual aspect may aid a user in quickly understanding the overall scenario and various details from one display 10. The display 10 may aid the user in determining how decisions are made inside an organization and how external forces may impact such decisions.

The software may store multiple main displays 10 associated with multiple organizations or multiple initiatives. A large organization may include a separate display 10 for each division or unit. The software may allow the user to select an individual 46 in one display 10 and query the stored displays 10 to see if the selected individual 46 appears in any other display 10. If an individual 46 does appear in other displays 10, the software may open the other display 10 and highlight the individual 46. Such a feature may allow the user to leverage resources (such as fans) from other organizations to influence an individual in a separate organization if the cross-organizational relationships exist.

The software may allow the user to add and store notes for each main display 10, which may include notes from a strategy session about that initiative and steps to take next to achieve the initiative. The software may email these notes through the communication module 44.

The user may implement and analyze “what-if” scenarios by making at least one change to a display 10 to see the result. For example, the user may see what would happen if an employee of the user goes to work for the competition. The user may simply select and reposition such an individual 46 in the competition object 16 and change that individual's relationship with the user from fan to enemy. The user would then be able to analyze the consequences and dynamics of such a move. For example, if the user's only positive relationship with key individuals 46 of the organization is through that employee, the user is at risk and should try to either establish more positive relationships through other employees or ensure that the employee in question has no incentive to go to the competition.

Another scenario may be if the CEO is replaced by another individual 46. The user may simply delete the previous CEO and move another individual 46 that the user thinks may be a candidate for CEO into the center 20 to see whether the change will be positive or negative for the user. In a similar way, the user may also analyze what would happen if any external influencer individuals 46 were to change.

Selecting an individual 46 in the main display 10 may show certain information associated with the individual 46. Such information may include that individual's contact information. Such information may also include the individual's attributes, such as how the individual 46 feels about the user and the influencing status of such individual within the organization. Such information may also include a list of individuals 46 with whom the selected individual 46 has a relationship, categorized by individuals 46 who the selected individual 46 likes, is neutral towards, dislikes, or has an undefined relationship with.

The above-described software and system may be available in multiple platforms, including, but not limited to, Mac, Windows, iOS, Android, Java, and Linux.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A computer comprising:
a processor;
at least one input device; and
at least one output device;
wherein the computer is programmed to:
a) show, using the at least one output device, a main display that shows 1) an organization object, 2) a user object, and 3) at least one competition object;
b) import data from a customer relationship management system and convert into individual objects;
c) populate the organization object, the user object, and the at least one competition object with the individual objects, wherein a number of the individual objects and a position of each individual object is determined using the at least one input device;
d) set and display attributes of each individual object, wherein the attributes are set using the at least one input device;
e) set relationships between any two individual objects using the at least one input device;
f) display the relationships between a selected individual object and all other individual objects with which the selected individual object has a relationship, wherein the selected individual object is selected using the at least one input device;
g) store a plurality of main displays; and
h) show the main displays in which a selected individual object appears when queried using the at least one input device.

2. The computer of claim 1,
wherein the attributes of each individual object include 1) a name, 2) whether the individual object is positive, neutral, negative, or undefined toward the user object, 3) whether the individual object is an influencer or a decision maker, and 4) whether the individual object is a difference maker; and
wherein the relationships between any two individual objects include whether one individual object is positive, neutral, negative, or undefined toward another individual object.

3. The computer of claim 2, further programmed to:
i) show at least one external influencer object, which may also be populated with the individual objects, wherein the number of external influencer objects and competition objects is determined using the at least one input device.

4. The computer of claim 3, further programmed to:
j) divide the organization object into hierarchical levels and subgroups, wherein the number of hierarchical levels and subgroups is determined using the at least one input device; and
k) display labels for at least one of 1) the at least one competition object, 2) the at least one external influencer object, and 3) the organization object subgroups, wherein the labels are set using the at least one input device.

5. The computer of claim 4, further comprising:
a communication module;
wherein the computer is further programmed to:
l) accept and store notes entered using the at least one input device; and
m) email the notes using the communication module.

6. The computer of claim 5, further programmed to:
n) operate according to a plurality of computer platforms.

7. The computer of claim 5, wherein a touch screen comprises the at least one input device and the at least one output device.

8. The computer of claim 5, wherein:
the organization object comprises a circle divided into 1) wedges representing subgroups, and 2) concentric rings representing hierarchical levels with the highest level in the center;
an individual object that is positive toward the user object is displayed with green color;
an individual object that is neutral toward the user object is displayed with yellow color;
an individual object that is negative toward the user object is displayed with red color;
an individual object that is undefined toward the user object is displayed with blue or purple color;
a green line represents a positive relationship of one individual object to another individual object;
a yellow line represents a neutral relationship of one individual object to another individual object;
a red line represents a negative relationship of one individual object to another individual object; and
a blue or purple line represents an undefined relationship of one individual object to another individual object.

9. The computer of claim 5, further programmed to:
o) indicate if the relationship of a first individual object toward a second individual object is not the same as the relationship of the second individual object toward the first individual object.

10. A method comprising the steps of:
a) providing a computer comprising:
a processor;
at least one input device; and
at least one output device;
b) initializing in the computer a main display that shows, using the at least one output device, 1) an organization object, 2) a user object, and 3) at least one competition object;
c) importing data from a customer relationship management system and converting into individual objects;
d) populating the organization object, the user object, and the at least one competition object with the individual objects, wherein a number of the individual objects and a position of each individual object is determined using the at least one input device;
e) setting and displaying attributes of each individual object, wherein the attributes are set using the at least one input device;
f) setting relationships between any two individual objects using the at least one input device;
g) configuring per steps a)-f) and storing a plurality of main displays;
h) selecting one individual object in one main display using the at least one input device; and
i) showing all other main displays in which the selected one individual appears.

11. The method of claim 10 further comprising steps:
j) selecting an individual object using the at least one input device; and
k) displaying the relationships between the selected individual object and all other individual objects with which the selected individual object has a relationship.

12. The method of claim 11,
wherein the attributes of each individual object per step e) include 1) a name, 2) whether the individual object is positive, neutral, negative, or undefined toward the user object, 3) whether the individual object is an influencer or a decision maker, and 4) whether the individual object is a difference maker; and
wherein the relationships between any two individual objects per step f) include whether one individual object is positive, neutral, negative, or undefined toward another individual object; the method further comprising step:
l) indicating on the main display if the relationship of a first individual object toward a second individual object is not the same as the relationship of the second individual object toward the first individual object

13. The method of claim 12, further comprising step:
m) showing in the main display at least one external influencer object, wherein the number of external influencer objects and competition objects is determined using the at least one input device;
wherein step d) further includes populating the at least one external influencer object with individual objects; and
wherein step b) further comprises dividing the organization object into hierarchical levels and subgroups, wherein the number of hierarchical levels and subgroups is determined using the at least one input device.

14. The method of claim 13, wherein each organization object of each of the plurality of main displays of step h) represents a unit of an organization.

15. The method of claim 13,
wherein the computer provided in step a) further comprises a communication module;
the method further comprising steps:
n) entering notes into the computer using the at least one input device and storing the notes; and
o) emailing the notes using the communication module.

16. The method of claim 15, wherein:
the organization object of step b) comprises a circle divided into 1) wedges representing subgroups, and 2) concentric rings representing hierarchical levels with the highest level in the center;
an individual object that is positive toward the user object per step e) is displayed with green color;
an individual object that is neutral toward the user object per step e) is displayed with yellow color;
an individual object that is negative toward the user object per step e) is displayed with red color;
an individual object that is undefined toward the user object per step e) is displayed with blue or purple color;
a green line represents a positive relationship of one individual object to another individual object per step f);
a yellow line represents a neutral relationship of one individual object to another individual object per step f);
a red line represents a negative relationship of one individual object to another individual object per step f); and
a blue or purple line represents an undefined relationship of one individual object to another individual object per step f).

17. The method of claim 16, wherein step d) further comprises positioning the individual objects within the organization object such that a distance between any two individual objects is representative of an intimacy of the relationship between the two individual objects.

18. The method of claim 17, further comprising step:
p) viewing the main display and ascertaining at least one of 1) key individuals related to an organization, 2) individuals with whom positive relationships should be established to achieve an initiative related to the organization, 3) relationships that may be used to aid in the establishment of the positive relationships, and 4) threats to achieving the initiative.

19. The method of claim 18, further comprising steps:
q) changing at least one individual object by 1) removing the at least one individual object from the main display, or 2) moving the at least one individual object to a different position on the main display; and
r) analyzing how the change in step q) affects the ascertainment in step p).

20. The method of claim 19, wherein a touch screen comprises the at least one input device and the at least one output device provided in step a).
